(19) United States
(12) Patent Application Publication
(10) Pub. No.: US 2024/0092659 A1
(43) Pub. Date: Mar. 21, 2024

(54) OILFIELD BRINE DESALINATION

(71) Applicant: STARROTOR CORPORATION, College Station, TX (US)

(72) Inventor: Mark Holtzapple, College Station, TX (US)

(73) Assignee: STARROTOR CORPORATION, College Station, TX (US)

(21) Appl. No.: 17/758,919

(22) PCT Filed: Jan. 14, 2021
(86) PCT No.: PCT/US2021/013513

§ 371 Date: Jul. 15, 2022

Related U.S. Application Data
(60) Provisional application No. 62/961,669, filed on Jan. 15, 2020.

(51) Int. Cl. C02F 1/26

(52) U.S. Cl. CPC C02F 1/265; C02F 2103/08; C02F 2201/002

(57) ABSTRACT

According to an embodiment of the disclosure, a desalination system includes a latent heat exchanger, a hydroclone, a compressor, and a quiescent vertical column. The latent heat exchanger is configured to receive saltwater. The latent heat exchanger includes tubes with an interior that are configured to circulate supersaturated brine with suspended salts. The hydroclone is configured to receive a flow from the latent heat exchanger. And, the hydrocodone has a flow that is substantially steam exiting the top and a flow that is substantially liquid exiting the bottom. The compressor that receives at least a portion of the flow that is substantially steam exiting the top of the hydroclone. An output of the compressor recirculating at least a portion of the flow back to the latent heat exchanger.

### CROSS-REFERENCE TO RELATED APPLICATIONS

This application claims the benefit and priority to U.S. Provisional Application No. 62/961,669 filed on Jan. 15, 2020. U.S. Provisional Application No. 62/961,669 is incorporated by reference for all purposes.

### TECHNICAL FIELD

This invention relates to desalination technologies and, more particularly, to oilfield brine desalination.

### BACKGROUND

In the oilfield, fracking has allowed for dramatic increases in the production of oil and gas. Fracking a typical well requires 5 to 10 million gallons of water, which is returned during approximately two to three weeks (230 to 700 bbl/h). After this “flowback” water is processed, then “connate” water (20 to 40 bbl/h) flows for the life of the well.

Typically, oilfield brine is disposed in injection wells, which involves significant expense for transportation and ultimate disposal. Depending on location, typical costs are $0.50 to $2.50/bbl (Texas) up to $10 to $14/bbl (Pennsylvania).

Sourcing water to frack wells is typically a problem. Generally, freshwater is employed, so there is competition from agriculture and municipalities. Some regions of the country (e.g., West Texas) are dry, so sourcing water can be a particular problem.

In the oilfield, major logistical challenges and costs are associated with the disposal of oilfield brine and sourcing of frack water. These costs are borne not only by private industry, but also municipalities that must maintain roads damaged by heavy truck traffic.

### SUMMARY OF THE DISCLOSURE

The present disclosure relates to desalination technologies and, more particularly, to oilfield brine desalination. According to an embodiment of the disclosure, a desalination system includes a latent heat exchanger, a hydroclone, a compressor, and a quiescent vertical column. The latent heat exchanger is configured to receive saltwater. The latent heat exchanger includes tubes with an interior that are configured to circulate supersaturated brine with suspended salts. The hydroclone is configured to receive a flow from the latent heat exchanger. And, the hydrocodone has a flow that is substantially steam exiting the top and a flow that is substantially liquid exiting the bottom. The compressor that receives at least a portion of the flow that is substantially steam exiting the top of the hydroclone. An output of the compressor recirculating at least a portion of the flow back to the latent heat exchanger.

a quiescent vertical column, wherein the flow that is substantially liquid exiting the bottom of the hydroclone has a portion of the flow that recirculates to the latent heat exchanger and another portion with salt that settle and accumulate at the bottom of the vertical column.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

### BRIEF DESCRIPTION OF THE DRAWINGS

For a more complete understanding of this disclosure and its features, reference is now made to the following description, taken in conjunction with the accompanying drawings and tables, in which:

FIG. 1 shows a process diagram, according to an embodiment of the disclosure;

FIG. 2 shows an example sanitary fitting that may be used according to embodiments of the disclosure;

FIG. 3 shows a chart for heat flux for 0.127-mm-thick titanium grade 2 with forced-convection pool boiling;

FIG. 4 shows a chart of the vapor pressure of saturated steam:

FIG. 5 shows the capacity of a smaller compressor;

FIG. 6 shows the capacity of a larger compressor;

FIG. 7 show engine efficiency;

FIG. 8a shows a Lock hopper with light sensor.

FIG. 8b shows a Lock hopper with sonic sensor;

FIG. 9a shows a countercurrent direct-contact heat exchanger with jet ejector and throttle valve;

FIG. 9b shows a countercurrent direct-contact heat exchanger with a jet ejector and turbine;

FIG. 9c shows a countercurrent direct-contact heat exchanger with a packed column and throttle valve;

FIG. 9d shows a countercurrent direct-contact heat exchanger with a packed column and turbine;

FIG. 10 show a steam driven crystallizer;

FIG. 11 shows a vapor-compression crystallizer;

FIG. 12 shows a thermocompressor crystallizer;

FIG. 13 shows Option 1, a horizontal heat exchanger with pump;

FIG. 14 shows a purge system for shaft seals;

FIG. 15 shows Option 2, a vertical heat exchanger with pump;

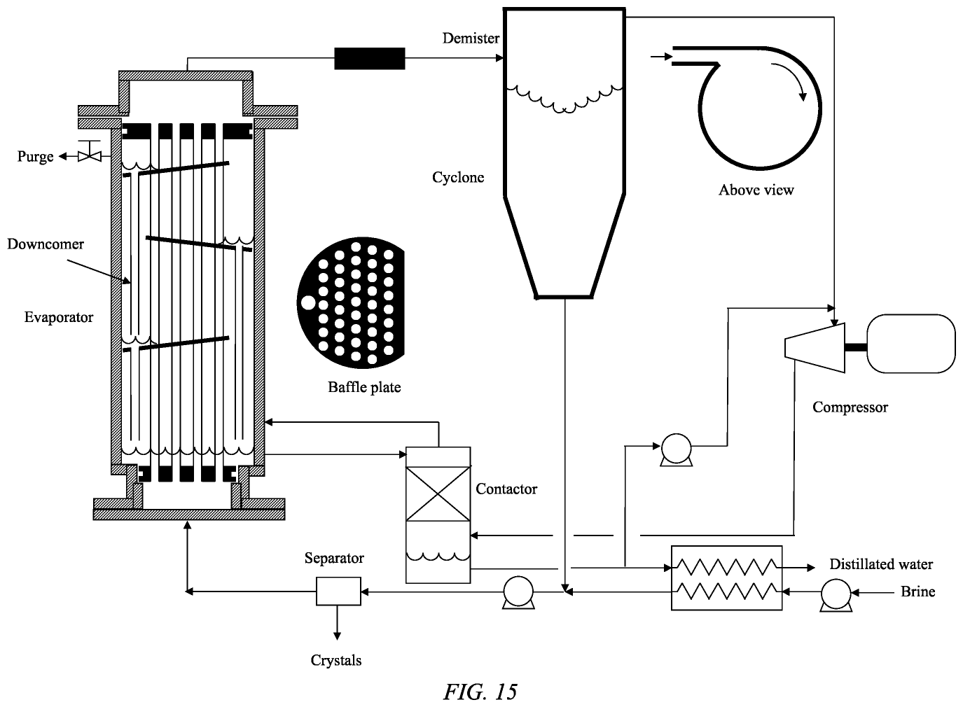

FIG. 16 shows Option 3, a vertical heat exchanger with cyclone/pump;

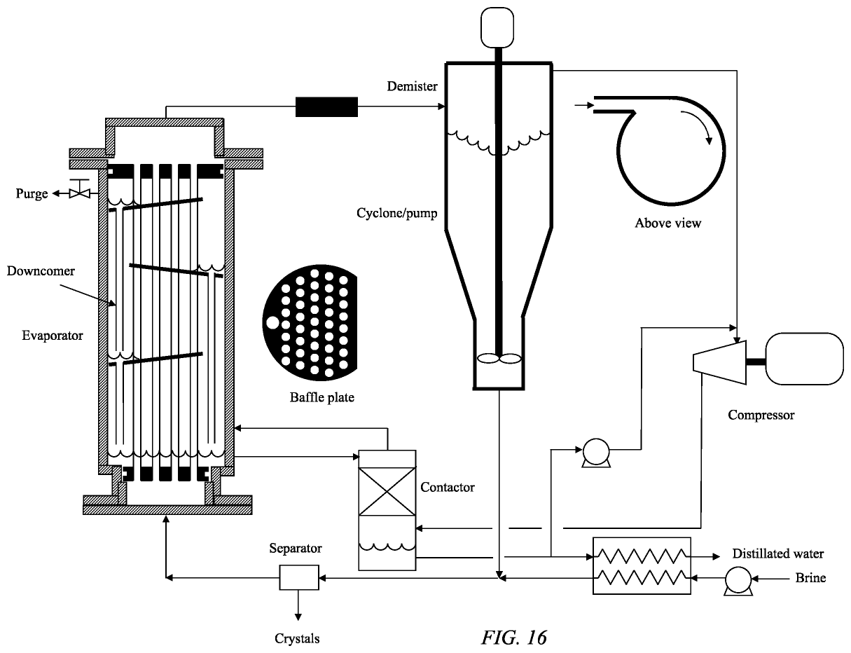

FIG. 17 shows Option 4, a Vertical heat exchanger with cyclone/pump and dual separator;

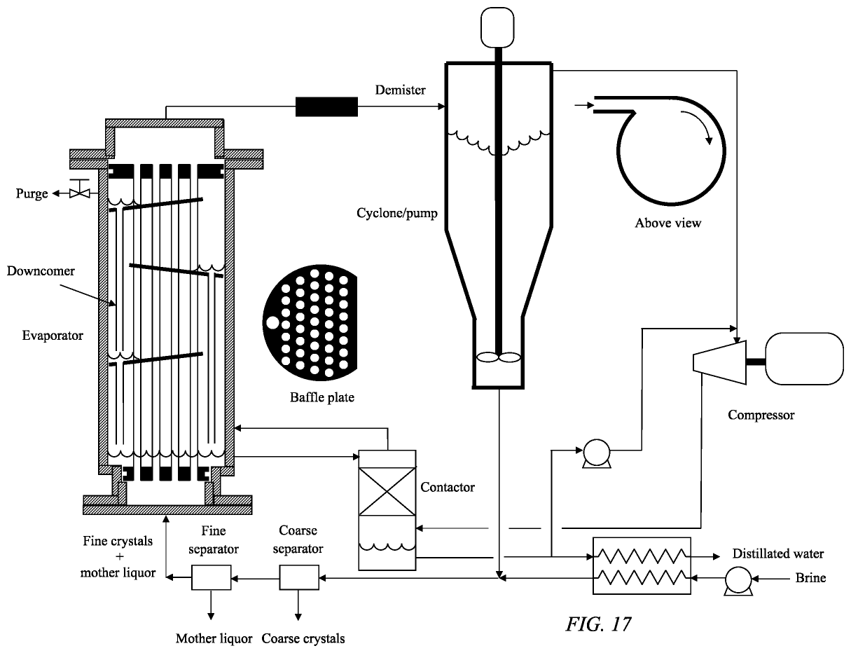

FIG. 18 shows a gravity separator;

FIG. 19 shows a gravity separator with upflow removal of fines; and

FIG. 20 shows options for removing interstitial liquid.

### DETAILED DESCRIPTION

The FIGURES described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

Given deficiencies described above, certain embodiment of this disclosure aims to dispose of oilfield brine in a cost-effective manner, and provide a source freshwater for fracking nearby oil wells, or for other uses (e.g., agriculture)

To reduce the logistical burden of transporting oilfield brine to a central processing facility, a decentralized model will be employed. A mobile desalination unit will be brought to the well that separates distilled water from the brine. The distilled water can be stored in a plastic-lined pit. If the region experiences active fracking, the water can be transported to nearby wells via plastic pipe. Alternatively, the water can be used by agriculture.

The isolated salts will be transported to a separate site for processing or disposal. Useful minerals (e.g., magnesium, potassium, lithium) can be isolated from the salt, or it can be disposed in a landfill or deep-well injection. Depending on the salt concentration in the raw oilfield brine, the amount of trucking can be reduced by roughly a factor of 10.

### Process Description

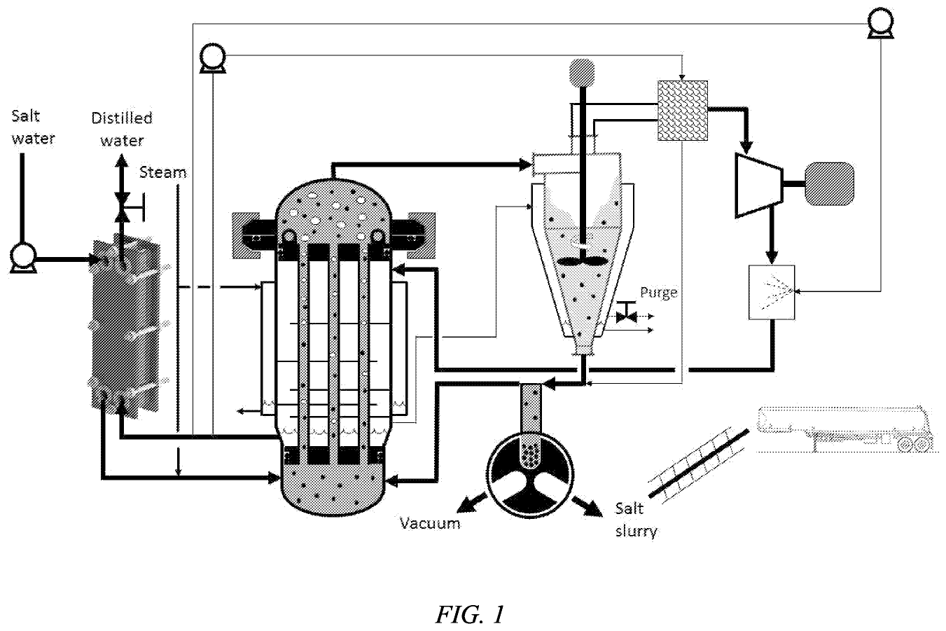

FIG. 1 shows a process diagram, according to an embodiment of the disclosure. While particular details and components are shown in this configuration, it should be understood that different details and components may be utilized in other configurations while still availing form the teachings of this disclosure.

The raw oilfield salt water is assumed to be minimally processed to remove solid particles (e.g., sand) and an oily phase. The saltwater is pumped to approximately 10 bar and flows through a countercurrent sensible heat exchanger. In particular configurations, a gasketed plate-and-frame heat exchanger may be utilized because it can be easily cleaned. In other configurations, other types of heat exchangers may be utilized. To heat the feed water to the final temperature, live steam is directly injected into the flowing stream.

The preheated oilfield brine enters the latent heat exchanger, which in particular configurations have vertical titanium 1-in-diameter, 8-ft-long tubes. The interior of the tubes has circulating supersaturated brine with suspended salts. The suspended salts serve two functions: (1) they scour the interior of the tube to prevent accumulation of fouling agents on the tube surface, and (2) they provide a preferential nucleation site that prevents accumulation of fouling agents on the tube surface. Furthermore, to prevent fouling, the tubes in particular configurations may be electropolished so they are ultra-smooth, which is known to reduce attachment of fouling agents.

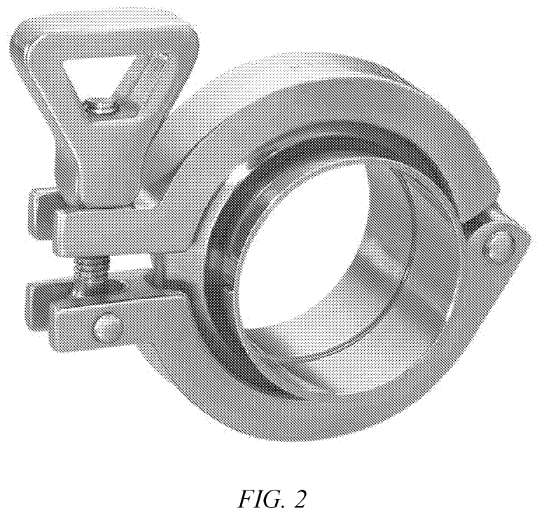

The latent heat exchanger in particular configurations is designed so the tube bundle can be readily removed and replaced in the event it must be cleaned. The upper head of the heat exchanger is secured with a locking mechanism similar to that used to secure sanitary fittings such as those shown in FIG. 2. A single screw—or hydraulically actuated mechanism—secures the head, so it can be removed quickly. In particular configurations, a crane mechanism will be incorporated into the unit that facilitates rapid removal of the heat exchanger core. A spare core can be kept in reserve that allows the unit to be rapidly returned to functionality while the fouled heat exchanger can be cleaned off site.

The interior walls of the shell and piping are clad with titanium, which is known to resist saltwater corrosion. While titanium is used in this particular configurations, other materials may also be used—including those especially resistant to saltwater corrosion.

The shell is jacketed to allow steam to be introduced into the annular space. The steam temperature sets the temperature of the evaporator, and also supplants losses through the insulation surrounding the latent heat exchanger. Furthermore, the steam preheats the system allowing it to be started from a cold condition. Potentially, a truck-mounted large-capacity steam generator may be used to rapidly put a cold system into operation. To improve energy efficiency, waste heat from engine exhaust could be used to produce steam, or provide heat to evaporate water via direct contact of outgoing exhaust with salt slurry.

The shell side of the latent heat exchanger has steam at a higher temperature (about 7° C.) than the circulating brine. The steam flows through a series of baffles with ever-shrinking spacing. This arrangement allows the steam velocity to be fairly uniform. Furthermore, it directs non-condensable gases to one location in the heat exchanger where they are concentrated and can be purged.

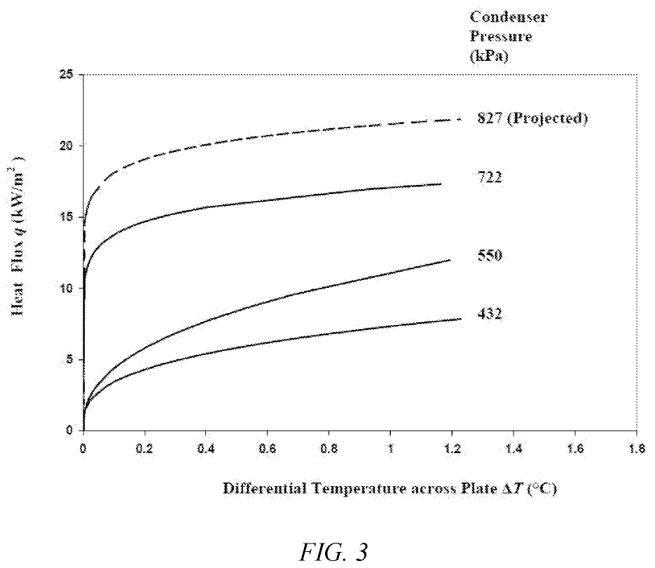

Titanium has a very strong oxide coating that is naturally hydrophobic and promotes dropwise condensation, which is desirable for excellent heat transfer. Under optimal conditions, at very small temperature differences (˜1° C.), the heat flux reaches a limits (FIG. 3). Presumably, this occurs because the tube surface accumulates so much adhering liquid water that it becomes insulating and limits additional heat transfer. Ultimately, the heat exchanger is limited by the rate that gravity allows liquid to shed from the tube surface and be collected. Under optimal conditions (thin wall thickness, optimal flow rates on interior and exterior, no fouling), the heat exchanger can operate with very small temperature differences (˜1C). Because optimal conditions are not likely to be present in the oilfield heat exchanger, a larger temperature difference (about 7° C.) is employed. This larger temperature difference imposes an energy penalty, but allows for robust operations, which is essential for a practical unit that operates largely unattended.

If the connection between the tube and baffle is tight, water that sheds from the tube will be collected by the baffle. This is desirable because water that adheres to the tube surface limits heat transfer. Tight-fitting baffles allow the water to be directed away from the tube surface, which increases heat exchanger performance. The water that collects on the exterior of the tubes falls, is collected by the baffles, and finally falls to the bottom of the heat exchanger. This distilled water product is removed through the countercurrent sensible heat exchanger and preheats the incoming feed water.

The brine that circulates through the tube interior is boiling, so bubbles must be disentrained. This is accomplished by directing the flow from the top of the heat exchanger to a hydroclone. The tangential inlet naturally causes the liquid to circulate in the hydroclone. Because liquid water has a higher density than steam, the liquid is disentrained from the steam. The steam exits the top and the liquid exits the bottom.

To encourage circulation, the hydroclone has a rotating impellor that further increases the circulation rate and also pressurizes the liquid and thereby improves the circulation rate through the heat exchanger. The shaft of the impellor exits the top of the hydroclone where there is steam and not salt water. This important feature ensures that the shaft packing stays clean and does not get fouled by salt, which would abrade the rotating shaft and cause a maintenance problem.

To ensure the hydroclone stays at temperature and does not cool the circulating liquid, it is jacketed. The purged steam from the heat exchanger flow through the jacket to ensure high temperature is maintained; thus, beneficial use is obtained from the purged steam.

The steam that exits the top of the hydroclone may have minor amounts of entrained salt water. To prevent salts from entering the compressor, the steam passes through a demister. Pure distilled water flows through the demister packing to wash away salts that could accumulate on the packing surface. To ensure it stays at temperature, the demister could also be jacketed (although not shown in FIG. 1).

The steam that enters the compressor is saturated. The steam exiting the compressor is superheated, which has poor heat transfer properties compared to saturated steam. To ensure that saturated steam enters the heat exchanger, the superheated steam exiting the compressor enters a desuperheater where it contacts a fine mist of liquid water. The fine mist has a large surface area that allow the liquid water to evaporate and hence remove the superheat.

The circulating brine has suspended salt particles that must be removed. As the liquid flows past a quiescent vertical column, larger salt particles will tend to settle and accumulate at the bottom of the vertical column. To remove the salt slurry, a rotary lock hopper is employed in certain configurations. The lock hopper has three sections, each with a different function: (1) filling with salt slurry, (2) discharge salt slurry, and (3) vacuum. The vacuum ensures that negligible air enters the system and thereby reduces the amounts of non-condensable gas that must be purged. Once the top section becomes filled with salt slurry, the valve rotates allowing the slurry to be discharged into an accumulator pit. As the accumulator pit fills with salt slurry, a screw conveyor removes the salt slurry and discharges it into a trailer. When the trailer is full, the screw conveyor is turned off allowing the full trailer to be removed and an empty trailer to take its place.

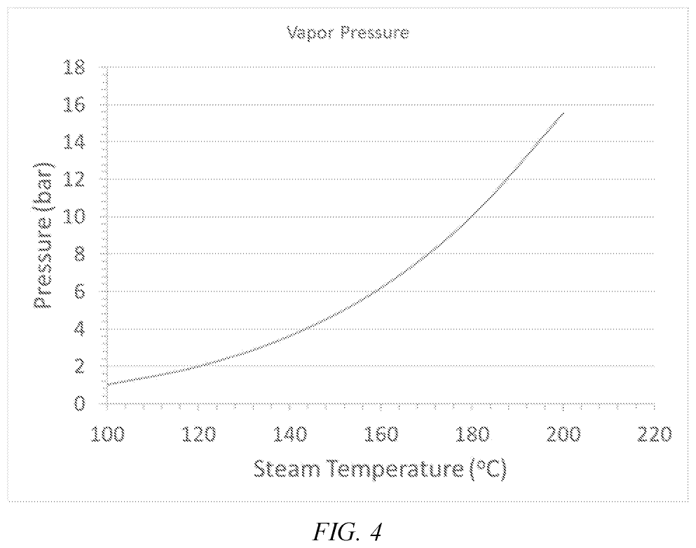

FIG. 4 shows the vapor pressure of saturated steam. To achieve good heat flux (FIG. 3), the latent heat exchanger must operate at roughly 7 bar (700 kPa).

Two compressors have been designed in detail and hence are good candidates for the portable desalination system. The properties of each compressor are shown below:

| | Compressor 1 | Compressor 2 |
|---|---|---|
| Outer rotor diameter (m) | 0.30 | 0.411 |
| Inner rotor length (m) | 0.11 | 0.154 |

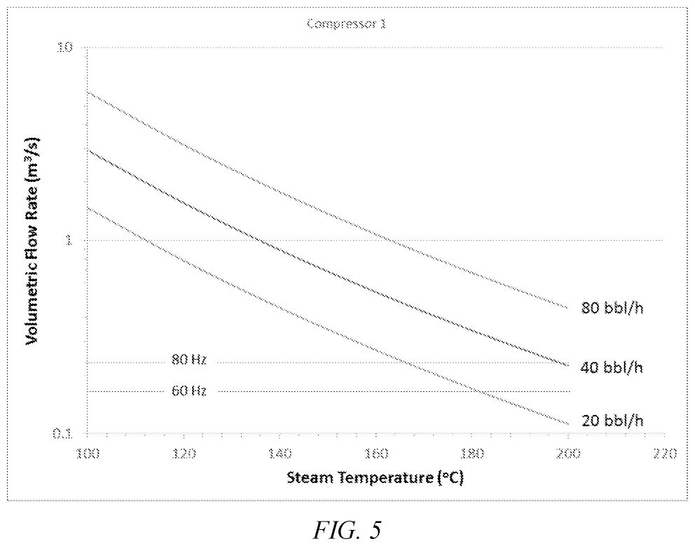

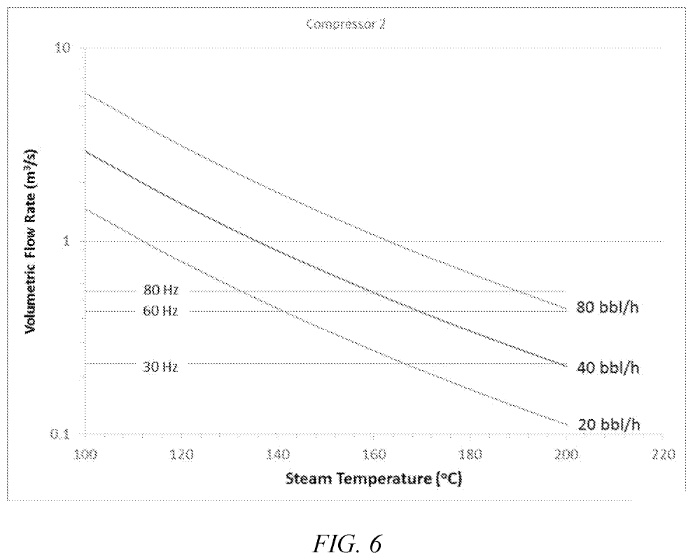

FIGS. 5 and 6 show the capacities of the smaller (Compressor 1) and larger (Compressor 2) machines, each operating at different rotation rates. Compressor 2 has much more versatile operating characteristics and allows for the following production rates:

| Product water (bbl/h) | 20 | 40 | 80 |
|---|---|---|---|
| Shaft speed (Hz) | 30 | 60 | 80 |
| Saturated steam temperature (° C.) | 168 | 172 | 190 |

FIG. 1 shows the compressor is powered by an electric motor, which is certainly an option if electricity is available. In the oilfield, it is expensive to run electric lines to remote locations. Furthermore, it is common for natural gas to be present, so it is common to deploy a gas-powered diesel engine in the oilfield.

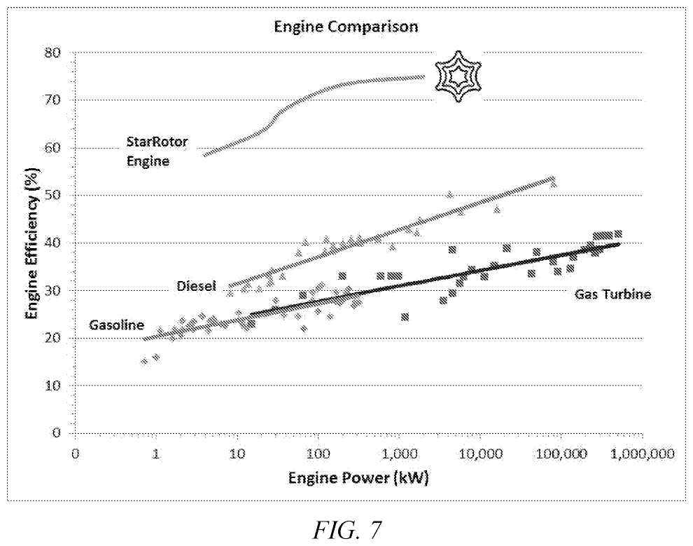

FIG. 7 shows the efficiency of engines that could be used to power the desalination system. Currently, diesel engines are the most efficient option; however, in particular configurations, an engine developed by the applicant, StarRotor, may be employed.

### Economics

Table 1 summarizes the capital cost of each scale: 20, 40, and 80 bbl/h. The capacity is based on distilled water produced, not oilfield brine fed. Details are shown in the appendix.

TABLE 1
Capital cost

| Product Water (bbl/h) | 20 | 40 | 80 |
|---|---|---|---|
| Feed pump | 2,000 | 4,000 | 5,000 |
| Sensible heat exchanger | 26,423 | 38,592 | 77,184 |
| Steam generator | 4,774 | 9,715 | 12,814 |
| Latent heat exchanger | 153,051 | 267,609 | 442,272 |
| Compressor | 150,000 | 150,000 | 150,000 |
| Diesel engine | 65,000 | 105,000 | 210,000 |
| Hydroclone w/impeller | 20,000 | 35,000 | 55,000 |
| Demister | 8,000 | 15,000 | 25,000 |
| Desuperheater | 4,000 | 7,000 | 13,000 |
| Lockhopper | 30,000 | 45,000 | 70,000 |
| Minor pumps | 6,000 | 8,000 | 10,000 |
| Screw conveyor | 4,600 | 5,700 | 6,700 |
| Total equipment cost | 473,848 | 690,616 | 1,076,970 |
| Lang factor | ×3.68 | ×3.68 | ×3.68 |
| Fixed capital investment (FCI) | 1,743,760 | 2,541,466 | 3,963,250 |

Table 2 summarizes the energy consumed by each component of the system. The energy costs are expressed on the basis of natural gas being fed to the diesel engine.

TABLE 2
Energy consumption (Btu/bbl)

| Product Water (bbl/h) | 20 | 40 | 80 |
|---|---|---|---|
| Feed pump | 876 | 830 | 789 |
| Sensible heat exchanger | — | — | — |
| Steam generator | 8,930 | 8,930 | 8,930 |
| Latent heat exchanger | — | — | — |
| Compressor | 38,862 | 36,592 | 34,763 |
| Diesel engine | — | — | — |
| Hydroclone w/impeller | 1,422 | 1,347 | 1,279 |
| Demister | — | — | — |
| Desuperheater | — | — | — |
| Lockhopper | 1,422 | 898 | 533 |
| Minor pumps | 1,422 | 1,122 | 746 |
| Screw conveyor | 947 | 750 | 426 |
| Total | 53,881 | 50,469 | 47,466 |

Table 3 shows the labor associated with operating the equipment. The “normal” labor associated with operating the equipment includes relocating the equipment from one site to another and periodic physical checking. Workers will be deployed according to the directions of a dispatcher. The smaller units (20 and 40 bbl/h) are ideal for processing produced water during the life of the well. The larger unit (80 bbl/h) is ideal for processing flow-back water. Because flow-back water is produced only for a short period (about 3 weeks), this unit is re-deployed more frequently than the smaller units.

TABLE 3
Normal labor utilization

| Product Water (bbl/h) | 20 | 40 | 80 |
|---|---|---|---|
| Relocations per year | 2 | 2 | 15 |
| Man hours per relocation¹ | 64 | 64 | 64 |
| Man hours per year | 128 | 128 | 960 |
| Routine visits per year | 50 | 50 | 50 |
| Man hours per visit | 8 | 8 | 8 |
| Man hours per year | 400 | 400 | 400 |
| Dispatcher hours per week³ | 4 | 4 | 4 |
| Man hours per year | 208 | 208 | 208 |
| Total man hours per year | 736 | 736 | 1568 |
| Labor rate ($/h)² | 30 | 30 | 30 |
| Overhead rate (%) | 33 | 33 | 33 |
| Total labor ($/h) | 40 | 40 | 40 |
| Annual labor cost ($/year) | 29,440 | 29,440 | 62,720 |

¹Two workers, two days for takedown and two days for setup
²Annual worker salary = $62,400/year
Annual median salary in United States in 2016 = $59,039
³10 units managed per dispatcher

Maintenance is a critical issue and represents the greatest uncertainty. Because the desalination systems are distributed to remote locations and the capacity is relatively small, it is essential that they run largely unattended. This is a common challenge in the oilfield, so remote monitoring is widely used. The desalination system must be fully monitored using various sensors, such as the following:
Vibrations sensors on all rotating equipment
a Temperature sensors at key locations
Pressure at key locations
Flow rates
a Rotation rates
a Liquid levels
a Salt levels
Cameras

This information is transmitted to a central location where a dispatcher monitors the performance. Should equipment have a maintenance issue, the dispatcher will send the maintenance workers to make the repair. Ideally, most of the repairs will be performed on a scheduled basis. For example, if a pump or compressor bearing is about to fail, it will vibrate well before the bearing fails. Once the vibration signal is detected, then the repair can be scheduled as needed.

Similarly, if a heat exchanger fouls, its performance will slowly degrade as indicated by increased temperature differences or reduced capacity. When unacceptable performance occurs, then the heat exchanger will be cleaned or the core replaced.

Tables 4, 5, and 6 summarize the desalination costs at each scale (20, 40, 80 bbl/h) under three maintenance scenarios: low, medium, and high. Costs range from $0.54 to $1.30/bbl, depending on the scenario. Because of economies of scale, the larger units are more cost effective. These costs do NOT include the cost of disposing of the concentrated salt slurry.

TABLE 4
Cost summary - Low maintenance cost (0.04 × FCI)
Product Water = 20 bbl/h

| | $/bbl | $/year |
|---|---|---|
| Insurance 0.007 × FCI | 0.077 | 12,206 |
| Maintenance 0.04 × FCI | 0.442 | 69,750 |
| Natural gas ($3.00/MMBtu) | 0.162 | 25,562 |
| Labor | 0.187 | 29,440 |
| Total | 0.868 | 136,958 |
| Utilization = 90% = 157,788 bbl/yr | | |
| Product Water = 40 bbl/h | | |
| | $/bbl | $/year |
| Insurance 0.007 × FCI | 0.056 | 17,790 |
| Maintenance 0.04 × FCI | 0.322 | 101,659 |
| Natural gas ($3.00/MMBtu) | 0.151 | 47,652 |
| Labor | 0.093 | 29,440 |
| Total | 0.622 | 196,541 |
| Utilization = 90% = 315,576 bbl/yr | | |
| Product Water = 80 bbl/h | | |
| | $/bbl | $/year |
| Insurance 0.007 × FCI | 0.044 | 27,743 |
| Maintenance 0.04 × FCI | 0.251 | 158,530 |
| Natural gas ($3.00/MMBtu) | 0.142 | 89,624 |
| Labor | 0.099 | 62,720 |
| Total | 0.536 | 338,617 |

Utilization = 90% = 631,152 bbl/yr

TABLE 5
Cost summary - Medium maintenance cost (0.06 × FCI)
Product Water = 20 bbl/h

| | $/bbl | S/year |
|---|---|---|
| Insurance 0.007 × FCI | 0.077 | 12,206 |
| Maintenance 0.06 × FCI | 0.663 | 104,626 |
| Natural gas ($3.00/MMBtu) | 0.162 | 25,562 |
| Labor | 0.187 | 29,440 |
| Total | 1.089 | 171,834 |
| Utilization = 90% = 157,788 bbl/yr | | |
| Product Water = 40 bbl/h | | |
| | $/bbl | $/year |
| Insurance 0.007 × FCI | 0.056 | 17,790 |
| Maintenance 0.06 × FCI | 0.483 | 152,488 |
| Natural gas ($3.00/MMBtu) | 0.151 | 47,652 |
| Labor | 0.093 | 29,440 |
| Total | 0.783 | 247,370 |
| Utilization = 90% = 315,576 bbl/yr | | |
| Product Water = 80 bbl/h | | |
| | $/bbl | $/year |
| Insurance 0.007 × FCI | 0.044 | 27,743 |
| Maintenance 0.06 × FCI | 0.377 | 237,795 |
| Natural gas ($3.00/MMBtu) | 0.142 | 89,624 |
| Labor | 0.099 | 62,720 |
| Total | 0.662 | 417,882 |

Utilization = 90% = 631,152 bbl/yr

TABLE 6
Cost summary - High maintenance cost (0.08 × FCI)
Product Water = 20 bbl/h

| | $/bbl | $/year |
|---|---|---|
| Insurance 0.007 × FCI | 0.077 | 12,206 |
| Maintenance 0.08 × FCI | 0.884 | 139,501 |
| Natural gas ($3.00/MMBtu) | 0.162 | 25,562 |
| Labor | 0.187 | 29,440 |
| Total | 1.310 | 206,709 |
| Utilization = 90% = 157,788 bbl/yr | | |
| Product Water = 40 bbl/h | | |
| | $/bbl | $/year |
| Insurance 0.007 × FCI | 0.056 | 17,790 |
| Maintenance 0.08 × FCI | 0.644 | 203,317 |
| Natural gas ($3.00/MMBtu) | 0.151 | 47,652 |
| Labor | 0.093 | 29,440 |
| Total | 0.944 | 298,199 |
| Utilization = 90% = 315,576 bbl/yr | | |
| Product Water = 80 bbl/h | | |
| | $/bbl | $/year |
| Insurance 0.007 × FCI | 0.044 | 27,743 |
| Maintenance 0.08 × FCI | 0.502 | 317,060 |
| Natural gas ($3.00/MMBtu) | 0.142 | 89,624 |
| Labor | 0.099 | 62,720 |
| Total | 0.787 | 497,147 |

Utilization = 90% = 631,152 bbl/yr

### ALTERNATIVE EMBODIMENTS

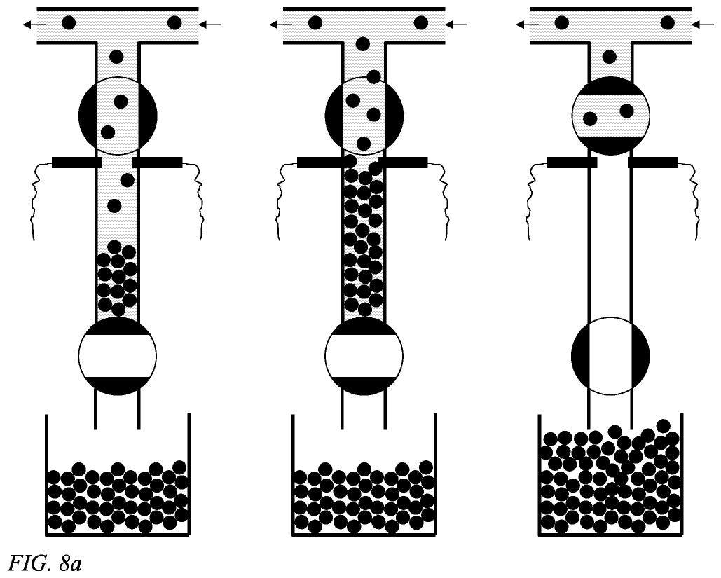

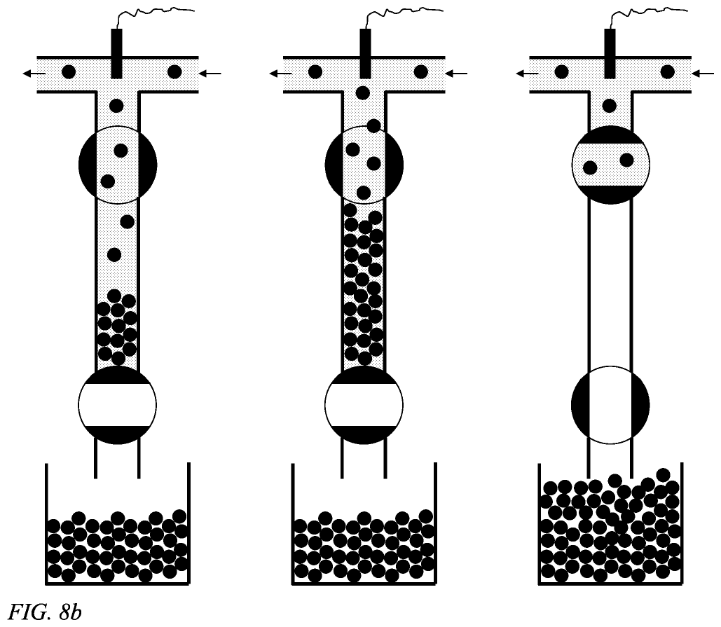

Rather than the rotary valve shown in FIG. 1, a pair of conventional valves can be employed in the “lock hopper” shown in FIGS. 8a and 8b. Circulating salt particles settle into the lock hopper pipe. When the sensor detects that the lock hopper pipe is full, the upper valve closes and the lower valve opens, allowing the salt to dump into the collector. A number of sensor options can be employed such as a light beam (FIG. 8a) or sound reflection from the top of the salt layer (FIG. 8b). The bottom of the collector can be porous, thus allowing free liquid to drain and be recycled back into the desalination system.

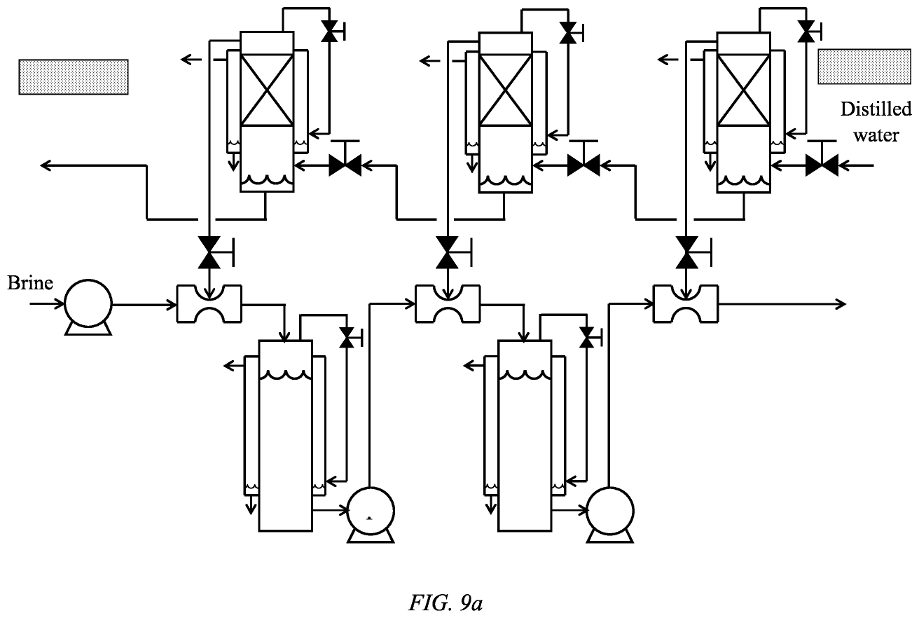

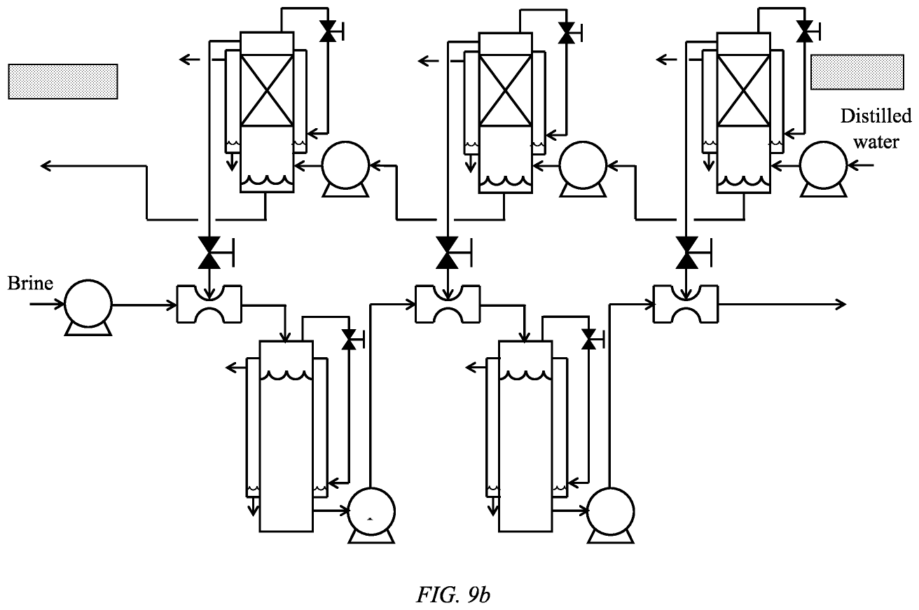

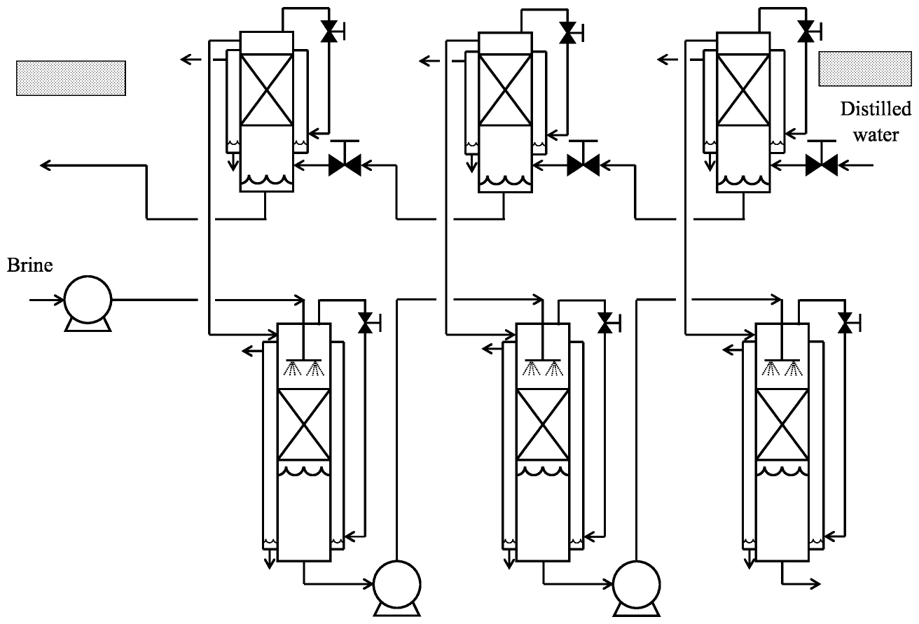

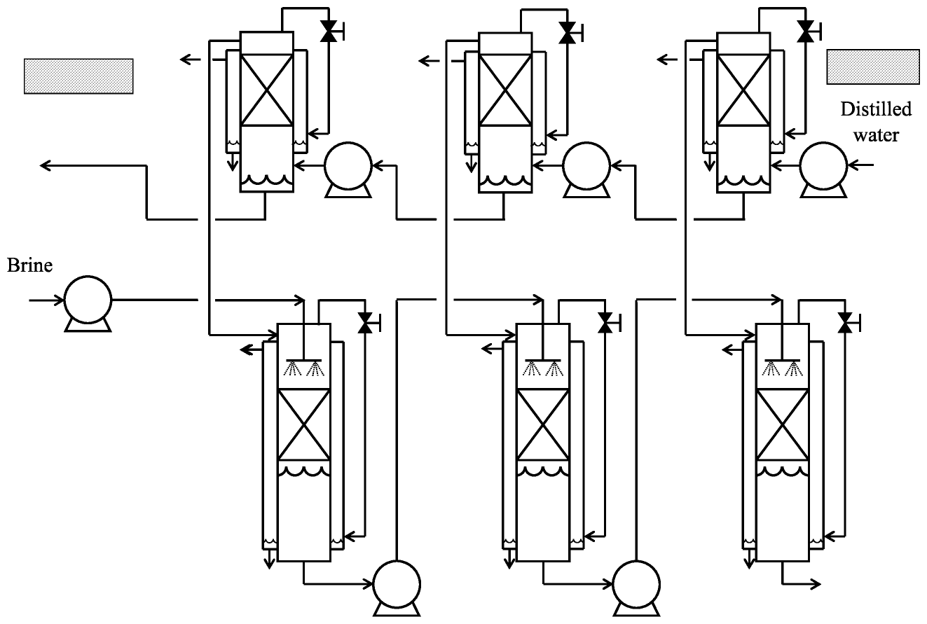

The sensible heat exchanger shown in FIG. 1 is prone to fouling, which reduces performance and increases maintenance costs. The impact of fouling can be drastically reduced by using direct-contact heat exchange shown in FIGS. 9a to 9d.

FIG. 9a shows hot distilled water entering at the upper right and cold brine entering at the lower left. The hot distilled water flows through a throttle valve that reduces the pressure causing a portion of the hot distilled water to flash. This throttle valve is regulated by the downstream pressure. At the top of the flash chamber, a demister knocks down entrained liquid. The dry flashed vapor enters the throat of a jet ejector where it mixes with the cold brine. A pump forces liquid through the jet ejector. The reduced pressure at the throat encourages the vapors to enter the brine where they condense causing the brine temperature to increase. To prevent cavitation in the pump, a column of liquid is present at the entrance to the pump, which provides hydrostatic head. The volumetric flowrate through the pump can be regulated by the height of the liquid column at the entrance to the pump. If the column height is too high, the pump speed is increased. If the column height is too low, the pump speed is decreased. A throttle valve regulates the flow of vapor into the throat of the jet ejector; this throttle valve can be controlled by the downstream brine temperature. If the downstream brine temperature is too high, the valve reduces the steam flow. If the downstream brine temperature is too low, the valve increases the steam flow. Although there is the potential for fouling minerals to attach to the walls of the jet ejectors, their performance is not severely affected allowing maintenance to be performed at convenient intervals. Furthermore, the high velocity flow through the jet ejectors will scour the surfaces to keep them clean. In FIG. 9a, three throttling stages are shown; however, fewer or more can be used. More throttling stages reduces the approach temperature between the two streams making the heat exchange more reversible, and hence more energy efficient. Because non-condensable gases are dissolved in the brine, it is necessary to purge them from the system. Each vessel has a small bleed stream that purges non-condensable gases, but also steam. The bleed stream is fed to the jacket on each vessel. Heat losses through the insulation will cause the steam to condense leaving the gas to be vented. The condensate is vented from the bottom of the jacket through a steam trap.

FIG. 9b is similar to FIG. 9a, except the throttle valves are replaced by turbines, which improves energy efficiency.

FIG. 9c is similar to FIG. 9a, except the jet ejectors are replaced by packed columns; each operates at the same pressure as the corresponding flash tank. Because each packed column operates at a different pressure, a separate pump must service each packed column. Because the fluid is near its boiling point, at the entrance to the pump, a liquid column is required which increases the fluid pressure at the pump entrance and prevents damaging cavitation in the pump.

FIG. 9d is similar to FIG. 9c, except the throttle valves are replaced by turbines, which improves energy efficiency.

### Detailed Cost Calculations

An Appendix detailed cost calculations is attached to provide additional information for the above referenced disclosures. Such cost calculations are not intended to limit the disclosure.

### Crystallization

Crystallization is widely employed to make many products, including sugar, salt, and pharmaceuticals. Also, crystallization can be used to reduce the volume of waste products, such as brine from water desalination and brackish water from oil and gas wells.

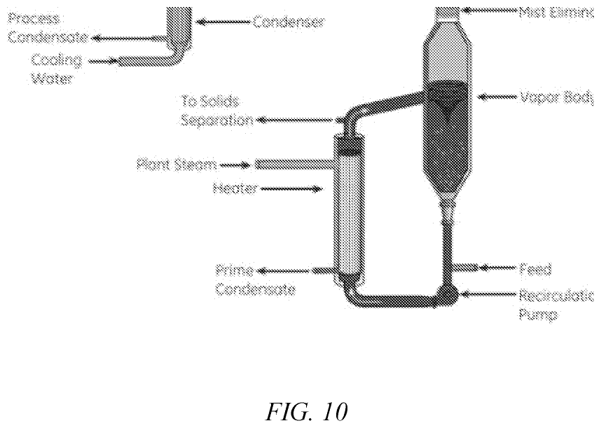

The most common crystallizers are steam-driven (FIG. 10). They employ single- or multiple-effect evaporators to remove the liquid solvent, which most commonly is water. As the solvent is removed, the solution becomes supersaturated, which allows the dissolved component to crystallize. If seed crystals are added and the crystallization is performed slowly, the crystal products are pure with most of the contaminants remaining in the mother liquor. For example, refined sugar is about 99.8% pure. The impurities (e.g., undesired sugars, minerals) are concentrated within the mother liquor, which is sold as molasses.

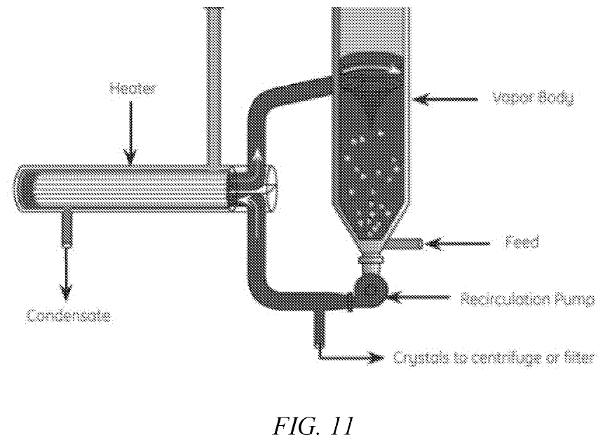

Vapor compression is an alternative method for evaporating the solvent (FIG. 11). The vapor recovered from the solution is mechanically compressed and is condensed in a heat exchanger that vaporizes the solution. The heat of evaporation is recycled; only a small amount of work is invested in the mechanical compressor. In essence, the vapor-compression system is a heat pump. Provided the temperature difference in the heat exchanger is small, the compressor requires only a small amount of work. The liquid exiting the heat exchanger contains entrained vapors, which are disentrained by passing through a cyclone. To ensure that solid-containing liquid does not enter the compressor, a demister is employed. As shown in FIG. 11, the precipitated solids are recovered using a filter or centrifuge.

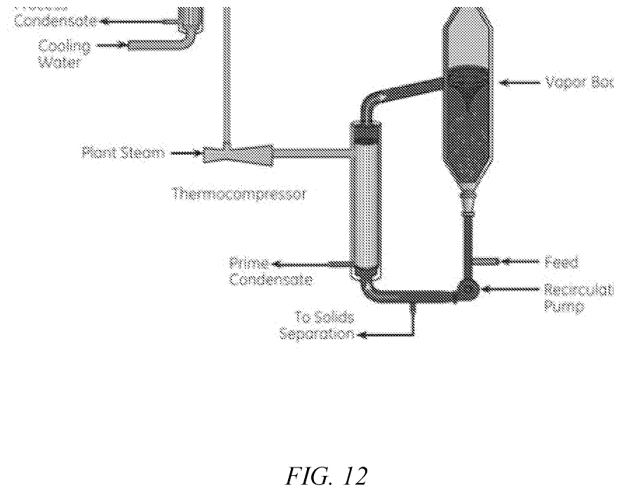

Rather than using a mechanical compressor, a jet ejector can be employed (FIG. 12). High-pressure steam is fed to the jet ejector, which compresses the steam recovered from the solution.

Although the basic principles of vapor-compression crystallization are known, embodiments described herein provide a series of details that improve the energy efficiency and operability.

### Option 1

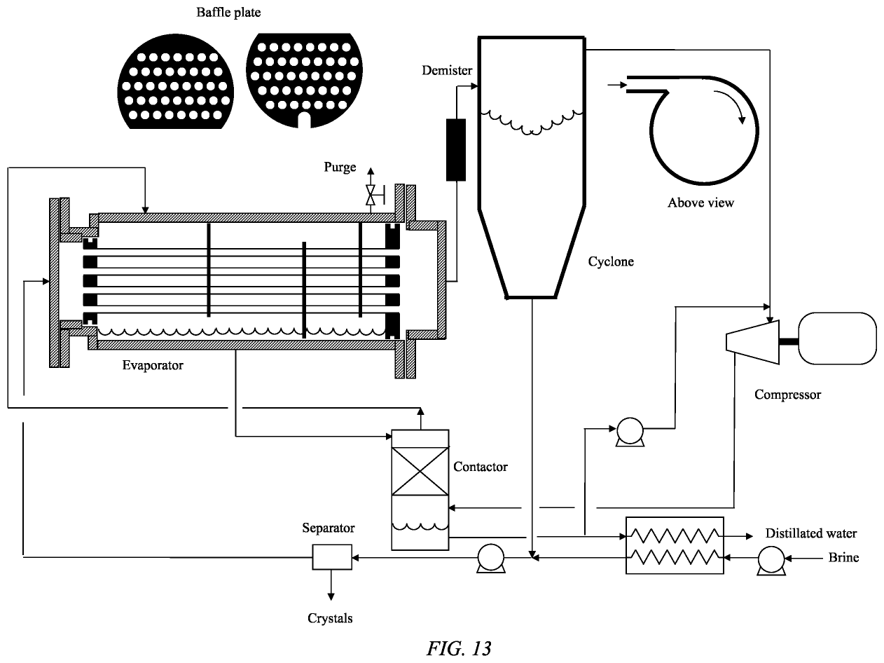

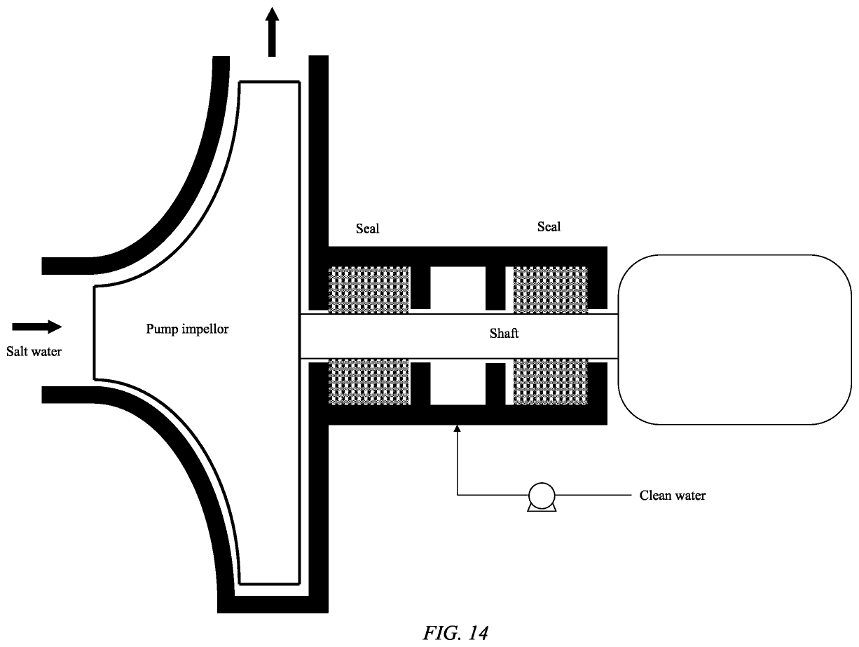

FIG. 13 shows a vapor-compression crystallizer with a horizontal heat exchanger. A pump circulates the solution through the heat exchanger. Option 1 is similar to the standard vapor-compression crystallizer depicted in FIG. 11; however, it incorporates the following improvements:
The shell side of the heat exchanger employs baffles that maintain a high steam velocity across the tubes, which enhances heat transfer. As the steam flows through the shell side, the spacing between the baffles reduces to maintain a nearly uniform steam velocity, which enhances heat transfer.
The baffle contains a slot that allows free exchange of liquid between the baffled sections of the shell side.
Any noncondensibles (e.g., air) in the steam collect at the farthest point (narrowest baffle spacing) in the heat exchanger and are purged. This feature ensures the steam partial pressure is high through nearly the entire heat exchanger, which ensures good heat transfer characteristics.
The tube sheets of the heat exchanger are captured in pockets located between the shell and the end caps. O-rings seal the tube sheets to the shell. Because the pockets have a gap in the axial direction, there is room for the tubes to thermally expand. Also, one tube sheet has a smaller diameter than the other, which allows the tube sheets to be readily removed from the shell in case servicing is required. A spare set of heat exchanger tubes provides redundancy, which allows for nearly continuous operation even if frequent tube cleaning is required.
The supersaturated liquid circulates through a nucleator, which promotes crystallization in the liquid rather than onto metal surfaces. Example nucleators are made by Colloid-A-Tron.
A fine mist of atomized liquid is sprayed into the compressor, which helps reduce superheating and improves energy efficiency. Example compressors that can tolerate liquids include gerotors, screws, and sliding vanes.
The compressed vapors exiting the compressor are sent to a contactor that contacts vapors with liquid. This removes residual superheat from the compressed vapors, which ensures that saturated vapor enters the heat exchanger and thereby maintains good heat transfer characteristics.
The circulating pump contacts a saturated solution. Any liquid that exits through the shaft seal will eventually evaporate leaving crystals that precipitate on the shaft, which will cause wear. This is prevented by pumping high-pressure clean water into the space between two shaft seals (FIG. 14). The clean water constantly purges solids from the seals, thus preventing wear.

Solid crystals are recovered from the circulating stream using a separator, such as a filter or centrifuge. If the solid recovery is nearly perfect, then the liquid returned to the heat exchanger is essentially free of solids. Alternatively, only a portion of the solids can be recovered from the circulating liquid. In this case, suspended solids flow into the heat exchanger, which can act as an abrasive to help scrub fouling solids that adhere to the interior walls of the tubes.

Optionally, Option 1 can employ a jet ejector to replace the mechanical compressor.

### Option 2

FIG. 13 shows Option 2, which is nearly identical to Option 1, except that the heat exchanger is vertical rather than horizontal. Ideally, the baffles are slightly slanted so that liquid collects at the downcomer and drains away from the heat exchanger tubes.

One advantage of the vertical heat exchanger is that vapor bubbles are buoyant, which enhances circulation, much like a thermo-siphon. A disadvantage is that if the tubes are too long, the liquid head prevents bubble formation. If the liquid cannot vaporize, its temperature rises, which requires a greater ΔT in the heat exchanger, which reduces energy efficiency.

Optionally, Option 2 can employ a jet ejector to replace the mechanical compressor.

### Option 3

FIG. 7 shows Option 3, which is nearly identical to Option 2, except that circulation is accomplished by placing an impellor in the cyclone. In essence, the cyclone also serves as a pump. The advantage of this approach is that the shaft penetrates the wall at the top of the cyclone, which has steam rather than a solution containing dissolved solids. At this location, there is little chance that salt will contact the shaft, so the purged seal system illustrated in FIG. 5 will not be necessary, thus simplifying the system.

Optionally, Option 3 can employ a jet ejector to replace the mechanical compressor.

### Option 4

FIG. 8 shows Option 4, which is nearly identical to Option 3, except that two separators are employed rather than one. The first separator removes coarse particles and the second removes fines. In some cases, only the coarse particles have a market, so this option allows coarse particles to be recovered separately.

The second separator must efficiently remove particles, which can be accomplished using a filter or a centrifuge. Although the recovered liquid can be free of solids, it does not mean that all of the solids are necessarily recovered in the second separator. If desired, the second separator can remove only a portion of the solids; the remaining solids can be circulated through the heat exchanger to act as an abrasive that removes fouling solids that adheres to the interior of the tubes.

Optionally, Option 4 can employ a jet ejector to replace the mechanical compressor.

### Separator

FIG. 9 shows a settler that serves as a separator rather than filer or centrifuge. The settler consists of a tank with a series of internal baffles that provides a turbulence-free zone. Any solids that enter the baffle area will eventually settle and collect at the low point in the settler.

FIG. 10 shows an alternative embodiment of the settler that selectively recovers coarse particles by purging fines. The design is essentially identical to the one shown in FIG. 9 except that vertical tubes are placed between the baffles. The exit of the vertical tube is located at a midpoint up the baffle. The zone above the exit has an upflow of solid-free mother liquor. (Note: The primary source of solid-free mother liquor is from the second separator.) The zone below the exit is quiet and allows particles to settle and be collected. The particle size is determined by the upflow velocity. A large velocity allows only the largest particles to settle. A low velocity allows most of the particle sizes to settle and removes only the smallest particles.

FIG. 11 shows the settler. The percentage recovery of solids is determined by the residence time. The residence time is readily adjusted by inserting an inlet pipe into the settler. If the inlet pipe extends deeply into the settler, the residence time is short and only a small portion of the solids are recovered. In contrast, if the inlet pipe does not extend deeply into the settler, the residence time is long and a larger portion of the solids are recovered.

FIG. 11 shows that the settled solids are removed using a lock hopper, which consists of two valves, a section of pipe, and a vacuum. The lock hopper operates in the following modes:

| Mode | Ball Valve 1 | Ball Valve 2 | Vacuum Valve |
|---|---|---|---|
| Prepare to charge | closed | closed | open |
| Charge | open | closed | closed |
| Discharge | closed | open | closed |

The interstitial water can be removed by filtration, a vibrating conveyor, or a centrifuge.
The filter can employ compressed air to blow out interstitial water. Example manufacturers of air-blown filters are Metso and FFP Systems, Inc.
The vibrating conveyor collects liquid below the porous conveyor.
The centrifuge collects liquid in the impermeable stationary bowl that surrounds the spinning porous bowl.
   The recovered mother liquor is returned to the evaporator. If the embodiment shown in FIG. 10 is used, the recovered mother liquor can be a portion of the upflow liquid. Although the interstitial liquid is substantially removed, the solids will still be damp. If bone-dry solids are desired, a dryer is required.

### Novel Features

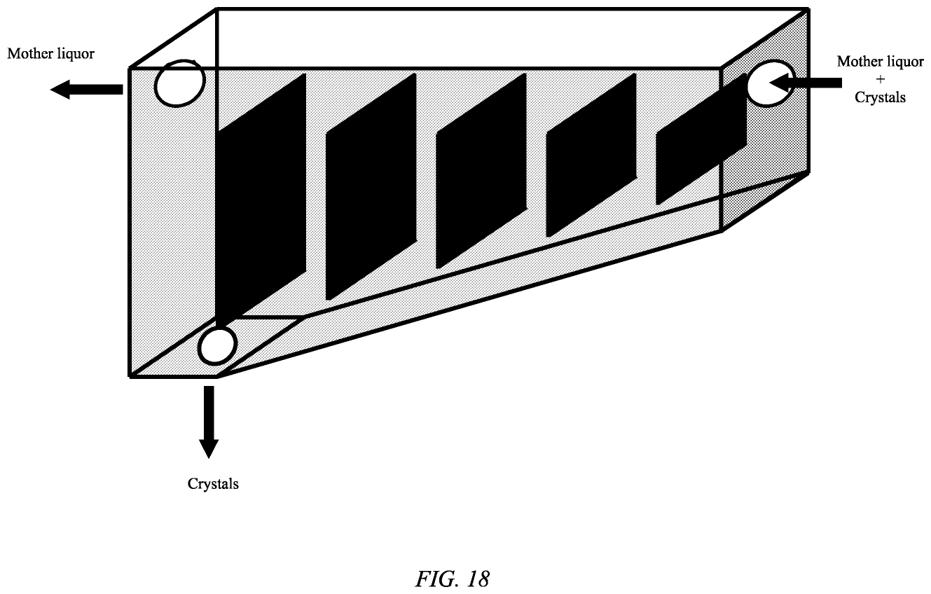

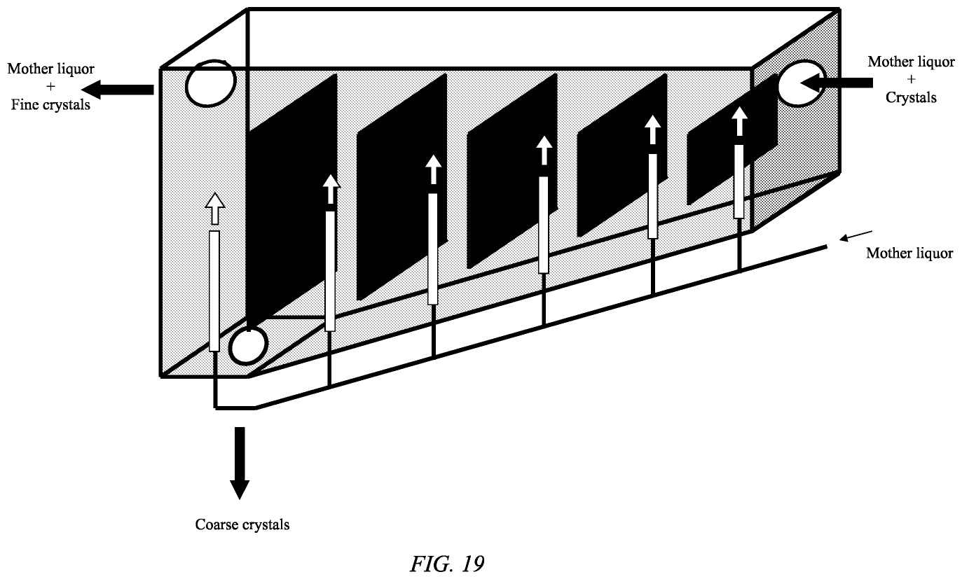

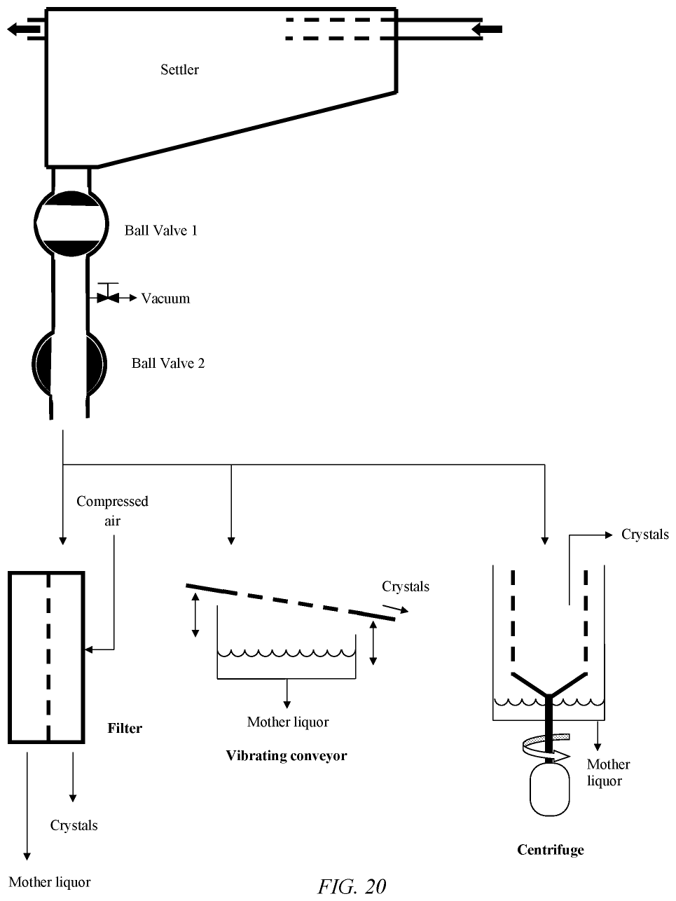

The following are non-limiting examples of novel features of this disclosure:
Baffles with spacing that reduces to maintain nearly constant steam velocity.
Baffle design for a horizontal heat exchanger that allows free exchange of liquid between the baffled sections of the shell side.
Purging noncondensibles from the farthest end of the shell side.
Heat exchanger tube sheets that are sealed to the housing using O-rings, which accomplishes the following:
   Tubes can expand thermally.
   Tube can be readily removed.
The use of a nucleator to promote crystallization in the liquid rather than onto metal surfaces.
A fine mist of atomized liquid is sprayed into the compressor, which helps reduce superheating and improves energy efficiency.
Using a contactor to remove superheat prior to entering the heat exchanger.
Purging two shaft seals with clean liquid water to prevent wear (FIG. 14).
Incorporating downcomers into baffles to remove condensed water.
Combining cyclone and pump into a single unit.
Employing multiple separators, each designed to remove different particle sizes.
Gravity separator with baffles (FIG. 18).
Gravity separator with upflow section to remove fines (FIG. 19).
Gravity separator with lock hopper (FIG. 20).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

[symbol]

What is claimed is:

1. A desalination system comprising:
a latent heat exchanger configured to receive saltwater, the latent heat exchanger including tubes with an interior that is configured to circulate supersaturated brine with suspended salts;
a hydroclone configured to receive a flow from the latent heat exchanger, the hydrocodone having a flow that is substantially steam exiting the top and a flow that is substantially liquid exiting the bottom;
a compressor that receives at least a portion of the flow that is substantially steam exiting the top of the hydroclone, an output of the compressor recirculating at least a portion of the flow back to the latent heat exchanger;
a quiescent vertical column, wherein the flow that is substantially liquid exiting the bottom of the hydroclone has a portion of the flow that recirculates to the latent heat exchanger and another portion with salt that settle and accumulate at the bottom of the vertical column.

2. The system of claim 1, further comprising a steam injector that applies steam to saltwater prior to entry into the latent heat exchanger.

3. The system of claim 1, wherein the tubes are vertical titanium tubes.

4. The system of claim 1, wherein the hydroclone further comprising a rotating impellor.

5. The system of claim 1, wherein
the hydroclone includes a jacket, and
purged steam from the latent heat exchange is configured to flow into the jacket to ensure high temperature is maintained.

6. The system of claim 1, further comprising:
a demister configured to receive the flow that is substantially steam exiting the top of the hydroclone to remove minor amounts of entrained salt.

7. The system of claim 1, further comprising:
a desuperheater that receives superheated steam from the compressor and removes the superheat prior to recirculating stream to the latent heat exchanger.

8. The system of claim 1, further comprising:
a lock hopper that removes the salt slurry from the quiescent vertical column.
